(19) United States
(12) Patent Application Publication
(10) Pub. No.: US 2018/0224917 A1
(43) Pub. Date: Aug. 9, 2018

(54) DEVICE AND METHOD FOR CONTROLLING APPLICATION PROGRAM

(71) Applicants: Samsung Electronics Co., Ltd., Gyeonggi-do (KR); Seoul National University R&DB Foundation, Seoul (KR)

(72) Inventors: Jin-Hyo KIM, Gyeonggi-do (KR); Ji-Hong KIM, Seoul (KR); Hyunghoon KIM, Gyeonggi-do (KR); Wook SONG, Seoul (KR)

(21) Appl. No.: 15/749,330

(22) PCT Filed: Jul. 29, 2016
(86) PCT No.: PCT/KR2016/008403

§ 371 Date: Jan. 31, 2018

(30) Foreign Application Priority Data
Jul. 31, 2015 (KR) 10-2015-0108836

(51) Int. Cl. G06F 1/32

(52) U.S. Cl. CPC G06F 1/324; G06F 1/3265; G06F 1/3228

(57) ABSTRACT

A method for operating an electronic device according to various embodiments may comprise the steps of: executing an application program in response to an input by a user; detecting a user perception response period in an execution period of the application program; and transmitting information on the user perception response period.

### TECHNICAL FIELD

The embodiments below relate to control of application programs.

### BACKGROUND ART

With the recent development of digital technology, various types of electronic devices, such as mobile communication terminals, smart phones, tablets, personal computers, personal digital assistants (PDAs), electronic diaries, notebooks, or wearable devices, have been widely used. The electronic device has evolved to a mobile convergence stage in which the electronic device encompasses functions of other devices. For example, the electronic device may provide a communication function, such as voice calls and video calls, a message transmission/reception function, such as SMS (short message service)/MMS (multimedia message service) and e-mail, an electronic diary function, a recording function, a broadcast reproducing function, a video reproducing function, a music reproducing function, an Internet function, a messenger function, a game function, a social networking service (SNS) function, and the like.

The various functions provided by the electronic device may be implemented through application programs.

### DETAILED DESCRIPTION OF THE INVENTION

### Technical Problem

The embodiments below are intended to provide a device and a method for controlling a processing speed of an application program.

In addition, the embodiments below are intended to provide a device and a method for controlling application programs to thus control power consumption.

### Technical Solution

A method for operating an electronic device, according to various embodiments, may include the steps of: executing an application program in response to an input by a user; detecting a user perception response period in an execution period of the application program; and transmitting information on the user perception response period.

An electronic device, according to various embodiments, may include: a controller; a communication unit configured to be operatively connected to the controller, and configured to transmit and receive data; and a display configured to be operatively connected to the controller, and configured to display a user interface (UI), wherein the controller is configured to: execute an application program in response to an input by a user; detect a user perception response period in an execution period of the application program; and transmit information on the user perception response period.

### Advantageous Effects

A device and a method, according to various embodiments, can improve the processing speed of an application program, and can reduce the power consumption of a device in which the application program is executed.

### BRIEF DESCRIPTION OF THE DRAWINGS

The following description will be made in detail with reference to the accompanying drawings in order to fully understand the present disclosure. A like element will bear a like reference numeral in the drawings.

FIG. 1 illustrates an example in which an application program is executed in an electronic device.

FIG. 2 illustrates a diagram showing an operation period of an application program with time in terms of the electronic device.

FIG. 3 illustrates a diagram showing an operation period of an application program with time in terms of a user, according to various embodiments.

FIG. 4 illustrates a plurality of execution paths of an electronic device executing an application program according to various embodiments.

FIGS. 5A to 5C illustrate scenarios that may occur according to various embodiments.

FIG. 6 illustrates a block diagram of an electronic device according to various embodiments.

FIG. 7 illustrates a block diagram of a controller according to various embodiments.

FIG. 8 illustrates a block diagram of a software framework of an electronic device according to various embodiments.

FIG. 9 illustrates a flowchart illustrating the operation of an electronic device according to the first embodiment.

FIG. 10 illustrates a flowchart showing a monitoring operation of an electronic device according to the first embodiment.

FIG. 11 illustrates an example of paths of an application program according to the first embodiment.

FIG. 12 illustrates a flowchart illustrating a frequency determining operation of an electronic device according to the first embodiment.

FIGS. 13A and 13B illustrate an energy saving effect according to the first embodiment.

FIG. 14 illustrates a graph showing changes in the frequency and the power consumption according to the first embodiment.

FIG. 15 illustrates an operation procedure between an electronic device and a host according to the second embodiment.

FIG. 16 illustrates a flowchart illustrating the operation of an electronic device according to the second embodiment.

FIG. 17 illustrates a GUI showing a centric and critical path according to the second embodiment.

### MODE FOR CARRYING OUT THE INVENTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

The terms used in the present disclosure are only used to describe specific embodiments, and are not intended to limit the present disclosure. A singular expression may include a plural expression unless they are definitely different in a context. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

Hereinafter, various embodiments of the present disclosure will be described based on an approach of hardware. However, various embodiments of the present disclosure include a technology that uses both hardware and software and thus, the various embodiments of the present disclosure may not exclude the perspective of software.

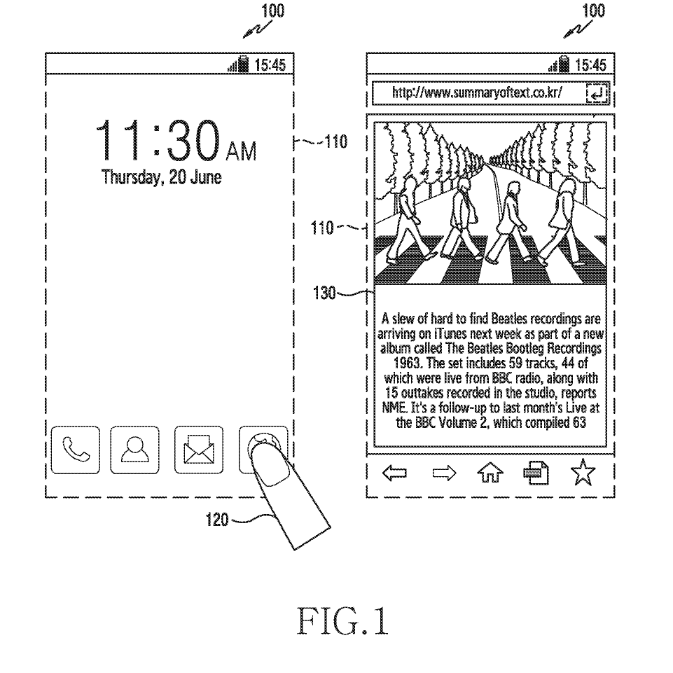

FIG. 1 shows an example in which an application program is executed in an electronic device.

Referring to FIG. 1, the electronic device 100 may provide a user interface (UI) 110 to the display. The user interface 110 may include a plurality of icons (or UI components that refer to sub-elements included in the UI) capable of executing various application programs. The electronic device 100 may execute an application program in response to a user input 120 such as a touch onto one of the plurality of icons. In response to the execution of the application program, the electronic device 100 may display user interface (UI) components 130, which refer to the elements of the UI, to be superimposed on the user interface 110. The application program may perform an additional calculation process even after the display of the UI component 130 is completed. That is, the application program may perform the displaying operation first in response to the execution of the application program, and may then be terminated after performing the remaining operations. In terms of the electronic device 100, the operation period of the application program may range from the execution time of the application program to the termination time of the execution thereof. On the other hand, in terms of a user, the operation period of the application program may range from the execution time of the application program to the completion time of the display of the UI component 130. It is due to the fact that the user cannot recognize the period after the completion of the display of the user interface (for example, the completion of the display of the UI component 130) because the period occurs inside the electronic device 100.

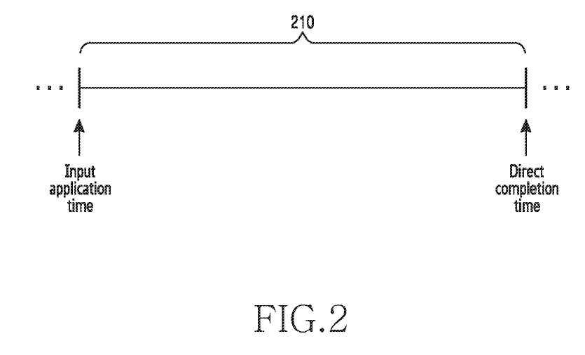

FIG. 2 is a diagram showing an operation period of an application program with time in terms of the electronic device.

Referring to FIG. 2, the operation period of an application program may be expressed as a computation-centric response period 210 in terms of the electronic device.

In executing a certain task (e.g., a function), the computation-centric response period 210 may be generally defined as a period from the time at which the task is started upon the reception of a necessary input to the time at which the task is explicitly completed. That is, the computation-centric response period 210 may range from the time at which a user input is applied to the time at which the task of the application program is completed. For example, if the execution of an application program brings about a chain of a plurality of tasks, the computation-centric response period 210 may be defined as a period from the input application time to the time at which all of the task chains are completed.

However, since the recent environment for using the electronic device has provided interaction through a user interface, the computation-centric response period 210 may not match a response period of the electronic device 100 that the user perceives. For example, if the last of the plurality of tasks is displaying the result on the display of the electronic device 100, the user may recognize the computation-centric response period as a perception response period 210. On the other hand, if the displaying on the display of the electronic device 100, among the plurality of tasks, is completed early, the user may recognize, as the perception response period, the time shorter than the computation-centric response period 210. Therefore, it may be required to define the operation period of the application program in terms of the user.

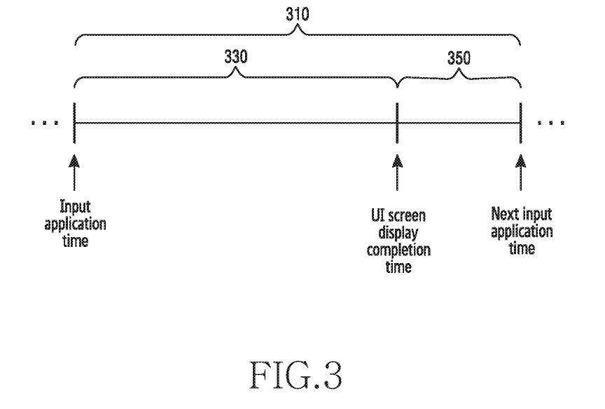

FIG. 3 is a diagram showing an operation period of an application program with time in terms of a user according to various embodiments.

Referring to FIG. 3, the operation period of an application program may be expressed as an interactive session 310 in terms of a user.

In general, the recent operation scenarios of the electronic device (e.g., the electronic device 100 of FIG. 1) may be configured with user inputs (e.g., a touch onto the screen, a voice input, etc.) at irregular time intervals. For example, if a user applies an input to the electronic device 100, the electronic device 100 may provide feedback to the user in response to the input. In addition, the user may apply a new input in response to the feedback. Therefore, the interactive session 310 may mean a time period from the input application time to the next input application time.

The interactive session 310 may include a user perception response period 330 and a user-oblivious response period 350.

The user perception response period 330 may be defined as a period from the time at which a user input is applied to the time at which the display of the user interface is completed. In other words, the user perception response period 330 may be a period in which a user applies an input and feedback thereto is provided. If a processing speed of the electronic device 100 is low in the user perception response period 330, the user may regard this as degradation in the performance of the electronic device 100.

The user-oblivious response period 350 may be defined as a period from the time at which the display of the user interface is completed to the time at which a next user input is applied. In other words, the user-oblivious response period 350 may be a period in which the user identifies and interprets the feedback of the electronic device 100 expressed through a user interface and then applies a next input. Even if the processing speed of the electronic device 100 is low in the user-oblivious response period 350, the user may not regard this as degradation in the performance of the electronic device 100.

Various embodiments of the present disclosure may provide a device and a method for setting the user perception response period 330 as short as possible. Furthermore, various embodiments of the present disclosure may provide a device and a method for reducing power consumption of the electronic device 100 by lowering the processing speed of the electronic device 100 in the user-oblivious response period 350.

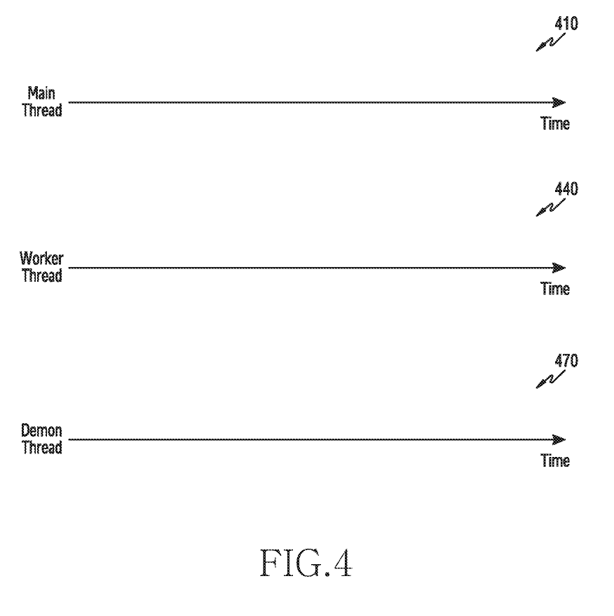

FIG. 4 illustrates a plurality of execution paths of an electronic device executing an application program according to various embodiments.

The latest electronic device (for example, the electronic device 100 in FIG. 1) may utilize a plurality of threads (a multi-thread) to process tasks. The multi-thread may be a concept different from a multi-process. The multi-thread and the multi-process may be similar in that they both simultaneously process a plurality of tasks. However, the respective processes in the multi-process occupy separate memories, whereas the multi-thread may share the memory in the process for usage. Therefore, a conversion speed between the threads may be higher than that between the processes. Therefore, an electronic device utilizing the multi-thread may have an advantage in terms of responsiveness. The plurality of threads may include a main thread, a worker thread, and a demon thread.

Referring to FIG. 4, the main thread 410 may perform a function of processing a user input and a request for updating a user interface. The main thread 410 may be allocated or generated for each individual application program. The main thread 410 may perform tasks, such as input processing and UI updating, which allow the user to perceive the performance. The worker thread 440 may generally perform a function of processing complicated calculations or a large amount of data. The worker thread 440 may be generated when performing a task (e.g., storage I/O or network I/O), which takes a relatively long time compared to the task performed by the main thread 410.

The demon thread 470 may perform a function of assisting other threads. For example, the demon thread 470 may provide services in the background while an application is executed. When the main thread 410 or the like is terminated, the demon thread 470 may also be forced to terminate.

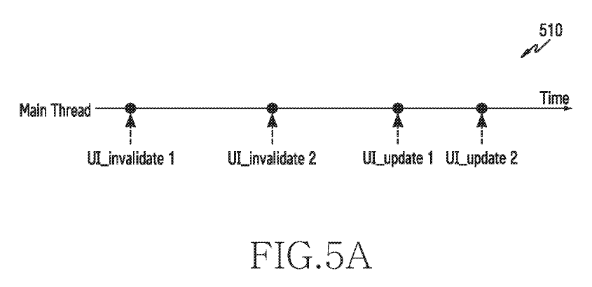

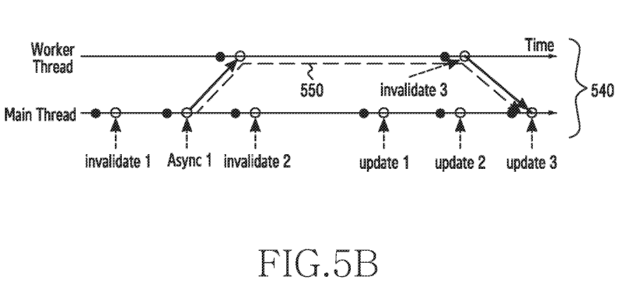

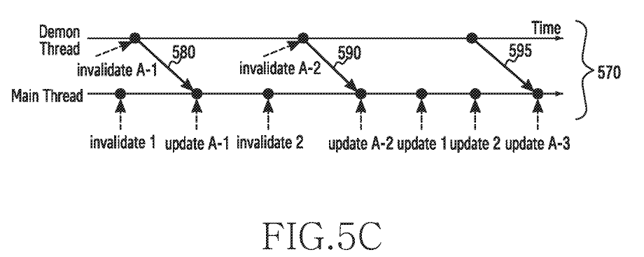

FIGS. 5A to 5C illustrate scenarios that may occur according to various embodiments.

Referring to FIG. 5A, a scenario 510 may be configured using only the main thread. In the scenario 510, the main thread may be comprised of a plurality of ‘UI_invalidates’ and a plurality of ‘UI_updates’. The ‘UI_invalidate’ may refer to an invalidation request for the UI component (e.g., the icons). The ‘UI_update’ may refer to an updating process of the UI component.

The scenario 510 may correspond to a situation in which both the invalidation request and the updating process for the UI component occur in the main thread. The electronic device 100 may perform the updating processes (e.g., UI_update 1 and UI_update 2) for the invalidation requests (e.g., UI_invalidate 1 and UI_invalidate 2), which are accumulated in a constant cycle, at one time, instead of performing the updating process (UI_update) immediately after the occurrence of the invalidation request (e.g., UI_invalidate). The scenario 510 may have the following operation procedure. A user input may call a callback method. The called callback method may generate an invalidation process (e.g., UI_invalidate 1 and UI_invalidate 2). In response to the generation of the invalidation process, the electronic device 100 may redraw the invalidated UI component through the updating process (e.g., UI_update 1 and UI_update 2).

A device and a method, according to various embodiments, may store a start time of the called callback method and the UI invalidation requests called in the corresponding callback method, and may check whether or not the UI invalidation requests are processed at the time of updating the UI component, thereby detect the user perception response period 330.

Referring to FIG. 5B, a scenario 540 may correspond to a form having a single worker thread added to the scenario 510. ‘Async’ may refer to the time at which the worker thread is generated or at which the main thread explicitly delegates a task to the worker thread that has already been generated. As described above, the update request for a UI and the updating operation for processing the same can be performed only by the main thread. Therefore, a direct update request in the worker thread may be limited. However, the worker thread may have a mechanism to delegate an updating task to the main thread. That is, when the worker thread delegates an updating task to the main thread, the main thread may generate an invalidation request to process the same. However, FIG. 5B illustrates an example in which the worker thread can directly make an invalidation request (e.g., invalidate 3) for the convenience of explanation. Although one worker thread is present in the scenario 540 as an example, there may be a plurality of worker threads.

A device and a method, according to various embodiments, in addition to the information to be identified in the scenario 510, may identify all of the UI invalidation requests, which have occurred in the worker thread delegated a task by the main thread, and the time for processing the invalidation request (e.g., the path 550 and update 3), thereby perceiving the user perception response period 330.

With reference to FIG. 5C, a scenario 570 may correspond to a form having a single demon thread added to the scenario 510. The scenario 570 may include the case in which an invalidation request, which is not related to a user input process, such as ‘invalidate A-1’ and ‘invalidation A-2’, occurs. For example, the path 580 and the path 590 may refer to a situation in which the UI component or the like is updated upon the receipt of events, such as advertisements, from the outside of the electronic device 100.

A device and a method, according to various embodiments, in addition to the information to be identified in the scenario 510, may identify all of the invalidation requests, which have occurred in the demon thread, and the time for processing the invalidation request (e.g., the paths 580, 590, and 595, update A-1, update A-2, and update A-3), thereby perceiving the user perception response period 330.

Although it is not illustrated in FIGS. 5A to 5C, various embodiments of the present disclosure may be applied to the scenario according to a combination of FIG. 5B and FIG. 5C (e.g., a combination of the main thread, the worker thread, and the demon thread).

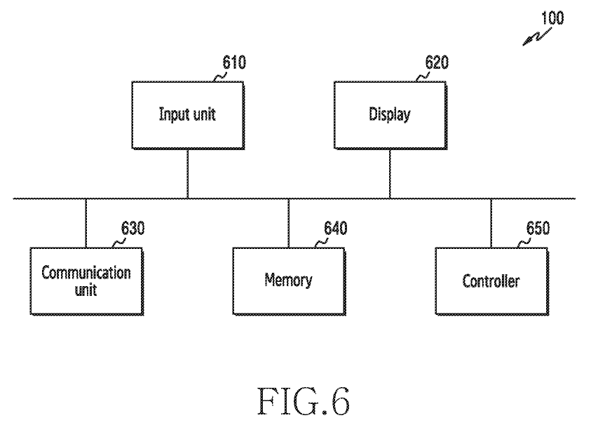

FIG. 6 illustrates a block diagram of an electronic device according to various embodiments. The electronic device 100 shown in FIG. 1 may have the same configuration as the block diagram of FIG. 6.

Referring to FIG. 6, the electronic device 100 may include an input unit 610, a display 620, a communication unit 630, a memory 640, and a controller 650.

The input unit 610 may receive instructions or data from the user. The input unit 610 may transmit the instructions or data to the display 620, the communication unit 630, the memory 640, or the controller 650. Furthermore, the input unit 610 may be implemented as a touch panel. The input unit 610 may detect a touch input using a finger or a pen or a hovering input. The input unit 610 may include a sensor. The sensor may be attached independently to the touch panel of the input unit 110. The sensor may include a sensor for detecting the location or motion of the electronic device 100 (e.g., an acceleration sensor, a geomagnetic sensor, or a gyro-sensor).

The input may be executed by touching and releasing or dragging and dropping. The input unit 610 may provide the controller 650 with an input received through a touch and data on the input.

The display 620 may be a liquid crystal display (LCD) or a light emitting diode (LED) display. The display 620 may display a variety of information (e.g., multimedia data or text data) to the user. For example, the display 620 may display a graphical user interface (GUI) for interaction between the user and the electronic device 100. When the user executes an application program through the input unit 610, the display 620 may display an execution result of the application program. The user may input new information or a new instruction through the input unit 610 in response to the display of the execution result of the application program.

The input unit 610 and the display 620 may be configured as an integral touch screen.

The communication unit 630 may be equipped with a variety of communication functions (e.g., LTE, Bluetooth, NFC, or the like) for communication with the electronic device 100 and external systems. The communication unit 630 may establish communication between the electronic device 100 and external devices. For example, the communication unit 630 may be connected to a network through wireless or wired communication in order to thereby communicate with the external devices.

The communication unit 630 may transmit data, which contains path information of the application program processed by the controller 650, to a developer of the application program or the like. Moreover, the communication unit 630 may receive update data made by improving the path information of the application program by the developer of the application program or the like. The received update data may enhance the performance of the application program.

The memory 640 may refer to one or more memory groups. The memory 640 may store data and/or instructions received from or generated by other elements (e.g., the input unit 610, the display 620, the communication unit 630, or the controller 650).

In order to execute the application program, the memory 640 may include callback methods for processing user inputs, methods used for exchanging messages between the main thread and the worker thread, methods necessary for generating a new worker thread, methods for invalidation and update of the UI components, and methods corresponding to a storage I/O and a network I/O.

The controller 650 may be implemented by SoC (system on chip). Furthermore, the controller 650 may be separated into pieces, and may be configured to be combined with the internal elements (e.g., the input unit 610, the display 620, the communication unit 630, the memory 640, or the like) of the electronic device 100 as necessary.

The controller 650 may receive instructions from other elements (e.g., the input unit 610, the display 620, the communication unit 630, the memory 640, or the like), may interpret the received instructions, and may perform calculations or data processing according to the interpreted instructions.

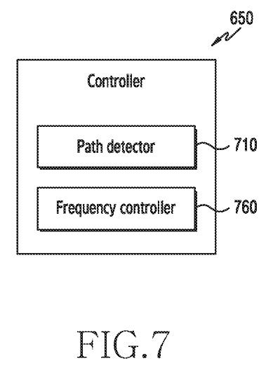

FIG. 7 shows a block diagram of a controller according to various embodiments. The controller 650 shown in FIG. 6 may have the same configuration as the block diagram of FIG. 7.

Referring to FIG. 7, the controller 650 may include a path detector 710 and a frequency controller 760.

The path detector 710 may monitor calls and returns of all methods that are called during the execution of the application program. Furthermore, the path detector 710 may dynamically extract the factor of each target method to be monitored and a member field of the class to which the monitored target method belongs.

The path detector 710 may monitor methods used for exchanging messages in order to determine the completion time of the user perception response period, methods necessary for generating a new worker thread, and methods for invalidation and update of the UI components.

The path detector 710 may monitor the methods corresponding to the storage I/O and the network I/O in order to analyze the centric and critical path. The centric and critical path flow may refer to a path having the longest period for determining the user perception response period among a plurality of paths corresponding to the user perception response period.

The path detector 710 may detect a plurality of paths that occur during the execution of the application program based on the target methods to be monitored.

The path detector 710 may determine whether or not the current path corresponds to the user perception response period by monitoring the methods corresponding to the user perception response period (e.g., the methods used for exchanging messages, the methods necessary for generating a new worker thread, and the methods for invalidation and update of the UI components). When it is determined that the current path corresponds to the user perception response period, the path detector 710 may detect the current path. In addition, the path detector 710 may transmit, to the frequency controller 760, the information stating that the current path corresponds to the user perception response period. Furthermore, the path detector 710 may determine whether or not the current path corresponds to the user-oblivious response period. When it is determined that the current path corresponds to the user-oblivious response period, the path detector 710 may detect the current path. Moreover, the path detector 710 may transmit, to the frequency controller 760, the information stating that the current path corresponds to the user-oblivious response period.

The path detector 710 may transmit, to the outside, data including the detected path information through the communication unit 630 shown in FIG. 6. For example, the path detector 710 may transmit the data to the developer of the application program through the communication unit 630. The developer of the application program may recognize the path information of the application program through the received data. The developer of the application program may analyze the path information to thus improve the performance of the application program. For example, the developer of the application program may analyze the centric and critical path among the path information to thus reduce the centric and critical path. For example, if the centric and critical path includes operations of high complexity and low relativeness with respect to the UI, such as the storage I/O and the network I/O, the developer may extract the operations from the centric and critical path. The developer may transmit data containing the changed path information to the electronic device 100. The electronic device 100 may improve the performance of the application program (especially, the performance of a program that the user perceives) by reflecting the data containing the changed path information through the communication unit 630.

The frequency controller 760 may control the processing speed of the application program. The frequency controller 760 may control the frequency of the electronic device 100 or the controller 650 in order to thereby control the processing speed of the application program.

The frequency controller 760 may adjust the processing speed of the path corresponding to the user perception response period to be increased, based on the path information obtained from the path detector 710. The frequency controller 760 may calculate a frequency of the current sampling cycle of the path corresponds to the user perception response period. The frequency controller 760 may determine whether or not it is possible to increase a frequency of a next sampling cycle based on the frequency of the current sampling cycle calculated above. Whether or not it is possible to increase the frequency of the next sampling cycle may be based on the current state of the electronic device 100 (e.g., the types or the number of application programs currently running in the electronic device 100). When it is determined that it is possible to increase the frequency, the frequency controller 760 may increase the frequency of the next sampling cycle of the path corresponding to the user perception response period. On the other hand, when it is determined that it is impossible to increase the frequency, the frequency controller 760 may maintain the frequency of the next sampling period of the path corresponding to the user perception response period at the frequency of the current sampling period.

The frequency controller 760 may adjust the processing speed of the path corresponding to the user-oblivious response period to be reduced, based on the path information obtained from the path detector 710. The frequency controller 760 may calculate a frequency of the current sampling cycle of the path corresponds to the user-oblivious response period. The frequency controller 760 may determine whether or not it is possible to reduce a frequency of a next sampling cycle based on the frequency of the current sampling cycle calculated above. Whether or not it is possible to reduce the frequency of the next sampling cycle may be based on the current state of the electronic device 100 (e.g., the types or the number of application programs currently running in the electronic device 100). When it is determined that it is possible to reduce the frequency, the frequency controller 760 may reduce the frequency of the next sampling cycle of the path corresponding to the user-oblivious response period. If necessary, the frequency controller 760 may set the frequency of the next sampling cycle as a minimum frequency supported by the electronic device 100. On the other hand, when it is determined that it is impossible to reduce the frequency, the frequency controller 760 may maintain the frequency of the next sampling period of the path corresponding to the user-oblivious response period at the frequency of the current sampling period.

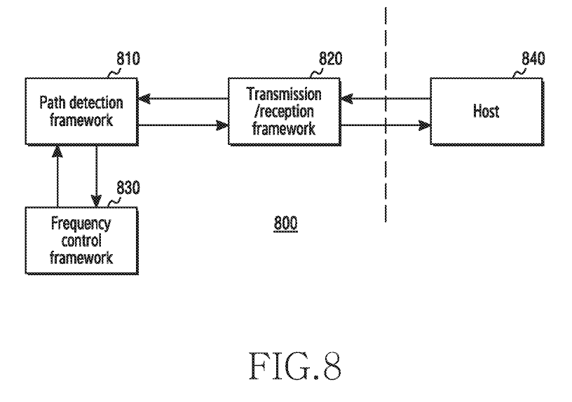

FIG. 8 illustrates a block diagram of a software framework of an electronic device according to various embodiments. The block configuration of the framework shown in FIG. 8 may be the software block configuration of the communication unit 610 and the controller 650 of FIG. 6 and an external electronic device.

Referring to FIG. 8, the electronic device 800 may include a path detection framework 810, a transmission/reception framework 820, and a frequency control framework 830. The electronic device 800 may be connected to a host (or PC) 840 as an external electronic device. The electronic device 800 may correspond to the electronic device 100.

Since a recent electronic device (e.g., the electronic device 100 of FIG. 1) operates through interaction with a user, the operation of the application program may be divided into minimal units, such as calls of methods and returns of results. That is, the path detection framework 810 may recognize whether or not the application program is processing a user input or is updating the UI by checking a call of a specific method or a call of a specific method group.

The path detection framework 810 may determine a completion time of the user perception response period by monitoring callback methods for processing a user input, methods for exchanging messages between the main thread and the worker thread, methods for generating a new worker thread, and invalidation and update methods for the UI components.

The path detection framework 810 may detect a plurality of paths generated by the execution of an application program by monitoring the methods. In particular, the path detection framework 810 may detect a plurality of paths corresponding to the user perception response period including a centric and critical path.

The path detection framework 810 may transmit information on the plurality of detected paths to the transmission/reception framework 820, the frequency control framework 830, or the like. The path detection framework 810 may be included in the controller 650 shown in FIG. 6.

The frequency control framework 830 may control the processing speed of a running application program. When an application is in operation, the frequency control framework 830 may control the processing speed of the application program based on the path information obtained from the path detection framework 810.

The frequency control framework 830 may adjust the processing speed of a path corresponding to the user perception response period to be increased. The procedure for increasing the processing speed may be performed as follows. The frequency control framework 830 may recognize a path corresponding to the user perception response period from the path detection framework 810. The frequency control framework 830 may determine whether or not it is possible to increase the frequency of the path corresponding to the user perception response period based on the information, the current state of the electronic device 100, and/or the frequency of the current sampling cycle. If it is possible to increase the frequency, the frequency control framework 830 may increase the frequency of the next sampling cycle to be higher than the frequency of the current sampling cycle. If it is impossible to increase the frequency, the frequency control framework 830 may maintain the frequency of the next sampling cycle at the frequency of the current sampling cycle.

The frequency control framework 830 may adjust the processing speed of a path corresponding to the user-oblivious response period to be reduced. The procedure for reducing the processing speed may be performed as follows. The frequency control framework 830 may recognize a path corresponding to the user-oblivious response period from the path detection framework 810. The frequency control framework 830 may determine whether or not it is possible to reduce the frequency of the path corresponding to the user-oblivious response period based on the information, the current state of the electronic device 100, and/or the frequency of the current sampling cycle. If it is possible to reduce the frequency, the frequency control framework 830 may reduce the frequency of the next sampling cycle to be lower than the frequency of the current sampling cycle. If necessary, the frequency control framework 830 may set the frequency of the path corresponding to the user-oblivious response period as a minimum frequency supported by the electronic device 100. If it is impossible to reduce the frequency, the frequency control framework 830 may maintain the frequency of the next sampling cycle at the frequency of the current sampling cycle.

The frequency control framework 830 may be included in the controller 650 shown in FIG. 6.

The transmission/reception framework 820 may perform a function of transmitting path information to an external device (e.g., the host 840) or the like.

The transmission/reception framework 820 may receive the detected path information from the path detection framework 810.

The transmission/reception framework 820 may transmit the received path information to the host 840. In addition, the transmission/reception framework 820 may receive updated path information from the host 840. The programming language used by the electronic device 100 including the path detection framework 810, the frequency control framework 830, and the transmission/reception framework 820 may be different from the programming language used by external devices including the host 840. The transmission/reception framework 820, according to various embodiments, may control the electronic device 100 to allow communication with an electronic device using a different programming language. For example, a socket server-client model may be applied to the transmission/reception framework 820.

The transmission/reception framework 820 may be included in at least one of the communication unit 630 or the controller 650 shown in FIG. 6.

The host 840 may receive path information from the transmission/reception framework 820 through wired or wireless communication. The host 840 may recognize a centric and critical path among the paths corresponding to the user perception response period based on the received path information. More specifically, the host 840 may establish a path corresponding to the user perception response period while inversely tracing from the thread requesting the last UI update toward the thread generating the same. When reaching the callback method through the established path, the host 840 may determine that the established path is the centric and critical path.

The host 840 may display the determined centric and critical path to a developer in the form of a graphical user interface (GUI).

The host 840 may update the determined centric and critical path. The host 840 may correct the centric and critical path through modification of the developer or the like or through a predetermined algorithm in the host 840. For example, if the centric and critical path includes operations taking a long processing time or having low relativeness to the UI (e.g., the storage I/O or the network I/O), and if it is possible to implement the operations through other paths, the host 840 may extract the operations from the centric and critical path. The excluded operations may be implemented through other paths. That is, the host 840 may generate a new centric and critical path based on the received information on the centric and critical path.

The host 840 may transmit information on the new centric and critical path to the transmission/reception framework 820. In response thereto, the transmission/reception framework 820 may update the path of the application program by providing the information to the path detection framework 810 or the like.

An electronic device, according to the various embodiments above, may include: a controller; a communication unit configured to be operatively connected to the controller, and configured to transmit and receive data; and a display configured to be operatively connected to the controller, and configured to display a user interface (UI), wherein the controller is configured to: execute an application program in response to an input by a user; detect a user perception response period in an execution period of the application program; and transmit information on the user perception response period. The execution of the application program may be comprised of a plurality of execution paths. The plurality of execution paths may include one of a first execution path associated with the display of at least one user interface screen for the application program, a second execution path supporting the first execution path, or a third execution path for processing an input received by the electronic device, or a combination thereof.

In various embodiments, the user perception response period may include a period from the time at which the application program is executed to the time at which the display of at least one user interface for the application program is completed, and the controller may be configured to further increase a processing speed of the application program in the user perception response period. The controller may be configured to: calculate a frequency of a current sampling cycle corresponding to the user perception response period; and increase a frequency of a next sampling cycle to be higher than the calculated frequency, thereby increasing the processing speed of the application program in the user perception response period.

In addition, in various embodiments, the user perception response period may include a period from the time at which the application program is executed to the time at which the display of at least one user interface for the application program is completed, and the controller may be further configured to reduce a processing speed of the application program in a user-oblivious response period from the time at which the display of at least one user interface is completed to the time at which the execution of the application program is terminated among the execution period. The controller may be configured to: calculate a frequency of a current sampling cycle corresponding to the user-oblivious response period; and reduce a frequency of a next sampling cycle to be lower than the calculated frequency of the period, thereby adjusting the processing speed of the application program to be reduced in the user-oblivious response period.

In addition, in various embodiments, the controller may be further configured to transmit first data including a plurality of paths to a second electronic device. The second electronic device may be an electronic device of a developer of the program. Furthermore, the controller may be further configured to receive second data from the second electronic device and to update the application program based on the second data, and the second data may include information to shorten the user perception response period from the execution time of the program to the time at which the updating of the display of at least one user interface for updating the application program is completed.

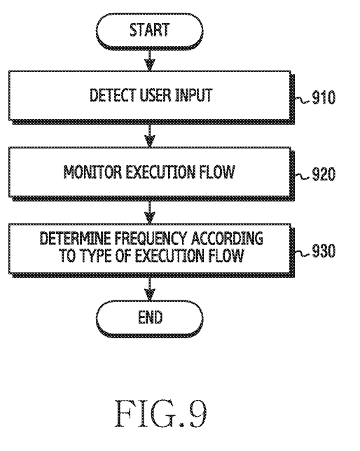

FIG. 9 is a flowchart illustrating the operation of an electronic device according to the first embodiment. This operation flow may be performed by the electronic device 100 shown in FIG. 1

Referring to FIG. 9, the electronic device 100 may detect a user input in step 910. The user input may mean an operation of a user for executing the application program. In addition, the user input may be received by the electronic device 100 through the input unit 610 shown in FIG. 6. For example, the user input may include an input through a keyboard, an input through a mouse, an input through a touch panel, an input through sensor sensing, an input through the communication unit 630 shown in FIG. 6, an input through a GPS, or the like. The electronic device 100 may transmit the user input to the controller 650 shown in FIG. 6. Although it is not shown in step 910, the electronic device 100 may execute an application program through an input by a user. The operation in step 910 may be performed by at least one of the input unit 610 or the controller 650.

In step 920, the electronic device 100 may monitor the paths generated by the running application program. The electronic device 100 may monitor at least one of a plurality of callback methods generated by the execution of the application program, a plurality of threads, or instructions and operations derived from the plurality of callback methods and threads. The electronic device 100 may determine whether the path corresponds to the user perception response period or the user-oblivious response period through the monitoring. The operation in step 920 may be performed by the controller 650 shown in FIG. 6.

In step 930, the electronic device 100 may determine the frequency based on the type of path. If the path corresponds to the user perception response period, the electronic device 100 may adjust the frequency corresponding to the path to be increased. On the other hand, if the path corresponds to the user-oblivious response period, the electronic device 100 may adjust the frequency corresponding to the path to be reduced. That is, the electronic device 100 may determine the frequency based on the type of path, and may adjust the processing speed of each path through the determination of the frequency. The operation in step 930 may be performed by the controller 650 shown in FIG. 6.

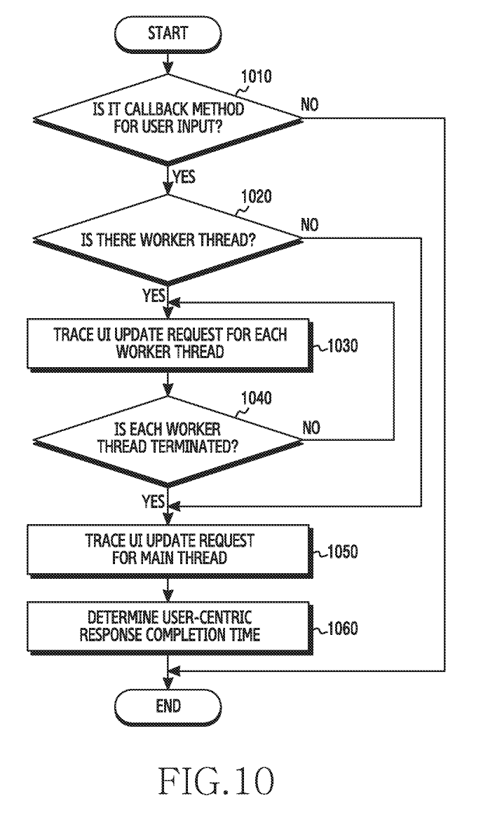

FIG. 10 is a flowchart showing a monitoring operation of the electronic device according to the first embodiment. The operation procedure may be performed by the electronic device 100 shown in FIG. 1.

Referring to FIG. 10, the electronic device 100 may monitor whether or not a callback method for a user input has occurred in step 1010. If a callback method for a user input has not occurred, the electronic device 100 may terminate the monitoring operation for the methods. This is because the absence of the callback method for a user input may mean the user input is not related to the execution of the application program. If the callback method for a user input has occurred, the electronic device 100 may perform the operation in step 1020. The operation in step 1010 may be performed by the controller 650 shown in FIG. 6.

In step 1020, the electronic device 100 may identify whether or not there is a worker thread. More specifically, the electronic device 100 may identify whether or not there is a worker thread associated with the callback methods. The worker thread may be an existing worker thread that has received a task due to the callback methods. In addition, the worker thread may be a newly generated worker thread due to the callback methods. A plurality of worker threads may be provided. If there is no worker thread, the electronic device 100 may perform the operation in step 1050. That is, if there is no worker thread, the electronic device 100 may perform the monitoring for the main threads. If there is a worker thread, the electronic device 100 may perform the operation in step 1030. The operation in step 1020 may be performed by the controller 650 shown in FIG. 6.

In step 1030, the electronic device 100 may track a UI update request for each worker thread identified in step 1020. For example, the electronic device 100 may track the UI update request for the worker thread by tracing the path 550 shown in FIG. 5. In general, the UI provided to the user may be comprised of UI components of a small unit. Accordingly, the electronic device 100 may internally manage the UI component that is the target of the UI update request. The operation in step 1030 may be performed by the controller 650 shown in FIG. 6.

In step 1040, the electronic device 100 may determine whether or not each monitored worker thread is terminated. If all of the monitored worker threads have not been terminated, the electronic device 100 may continue to trace the UI update request in step 1030. On the other hand, if all of the monitored worker threads have been terminated, the electronic device 100 may perform the operation in step 1050. The operation in step 1040 may be performed by the controller 650 shown in FIG. 6.

In step 1050, the electronic device 100 may track a UI update request for the main thread. The UI update requests may include a UI update request generated in the main thread, a UI update request generated in the demon thread and flowing into the main thread, and the like. The electronic device 100 may internally manage the UI component that is the target of the UI update request in step 1030. The electronic device 100 may track each UI update request until the processing of all of the UI update requests for the corresponding user input are completed. The operation in step 1050 may be performed by the controller 650 shown in FIG. 6.

In step 1060, the electronic device 100 may determine the completion time of the user perception response period based on the monitored information through the operations in steps 1010 to 1050. In addition, the electronic device 100 may detect the respective paths included in the application program executed by the user input based on the monitored information through the operations in steps 1010 to 1050. The operation in step 1060 may be performed by the controller 650 shown in FIG. 6.

The respective pieces of information obtained through the operations in the steps 1010 to 1060 may be transmitted to other elements of the electronic device 100 (e.g., the communication unit 630 or the like) or to other elements in the controller (e.g., the frequency controller 760 or the like) in each step. Alternatively, the respective pieces of information obtained through the operations in steps 1010 to 1060 may be transmitted to other elements of the electronic device 100 or to other elements in the controller after all of the steps are completed.

The operations in steps 1010 to 1060 may be performed in parallel, or may be performed with a change in the sequence thereof according to the embodiments.

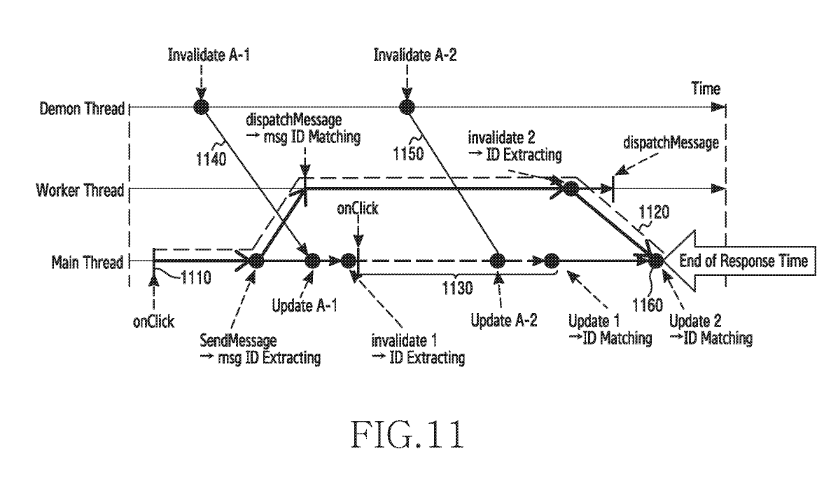

FIG. 11 shows an example of paths of an application program according to the first embodiment. The paths of an application program may occur within the electronic device 100 shown in FIG. 1.

Referring to FIG. 11, the paths of the application program may be implemented by one of the main thread, the worker thread, and the demon thread or by a combination thereof.

‘onClick’ 1110 may be a callback method generated in response to a user input for executing the application program. In FIG. 11, a path 1120 may be initiated by ‘onClick’ 1110.

A path 1120 may be implemented by a combination of the operation in the main thread and the operation in the worker thread. If ‘onClick’ 1110 is triggered by a user input, the main thread may delegate a task to the worker thread through ‘sendMessage’. At this time, the electronic device 100 may extract ‘msg ID’ of the ‘sendMessage’. In response to the task delegation of the main thread, the worker thread may initiate the task through ‘dispatchMessage’. At this time, the electronic device 100 may match the extracted ‘msg ID’. The worker thread may perform the delegated task to thus generate ‘invalidate 2’, and may transmit the same to the main thread. At this time, the electronic device 100 may extract an ID. The main thread may terminate the task on the path 1120 through ‘update 2’ 1160 in response to ‘invalidate 2’. At this time, the electronic device 100 may match the ID. The ‘update 2’ 1160 may indicate that the updating of the UI or the UI component corresponding to the path 1120 has been completed.

A path 1130 may be implemented by the operation in the main thread. The path 1130 may be terminated by performing ‘update 1’ in response to ‘invalidate 1’. The ‘update 1’ may indicate that the updating of the UI or the UI component corresponding to the path 1130 has been completed.

Paths 1140 and 1150 may be implemented by a combination of the operation in the main thread and the operation in the demon thread. The demon thread of the path 1140 may transfer the task for ‘invalidate A-1’ to the main thread. In addition, the demon thread of the path 1150 may transfer the task for ‘invalidate A-1’ to the main thread. The task in the path 1140 may be terminated through ‘update A-1’ of the main thread. In addition, the task in the path 1150 may be terminated through ‘update A-2’ of the main thread. The ‘invalidate A-1’ and ‘invalidate A-2’ may be generated by the information input from the outside of the electronic device 100 rather than a user input. For example, the ‘invalidate A-1’ and ‘invalidate A-2’ may be advertisements or the like received from the outside of the electronic device 100.

In FIG. 11, the user perception response period may be a period from the time of ‘onClick’ 1110 to the time of ‘update 2’ 1160. The electronic device 100 may detect the path 1120, the path 1130, the path 1140, and the path 1150 by monitoring ‘onClick’, ‘invalidate’, ‘update’, and the like. The electronic device 100 may transmit the information on the paths 1120 to 1150 to the outside. The information on the paths 1120 to 1150 transmitted to the outside may be used for improving the performance of the application program.

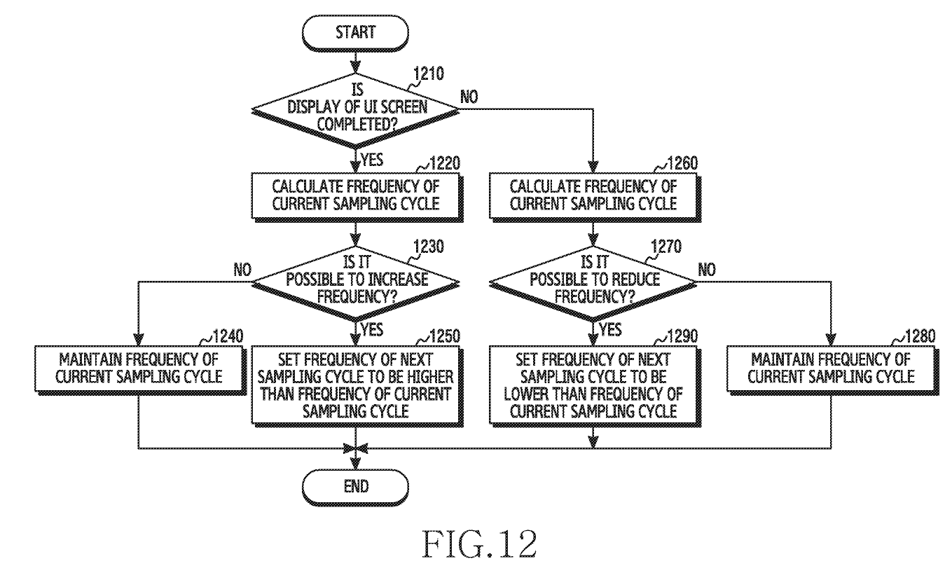

FIG. 12 is a flowchart illustrating a frequency determining operation of an electronic device according to the first embodiment. This operation flow may be performed by the electronic device 100 shown in FIG. 1.

Referring to FIG. 12, in step 1210, the electronic device 100 may check whether or not the display of the UI screen has been completed (i.e., whether or not the UI screen has been updated). Whether or not the display of the UI screen has been completed is checked because the operations after the completion of the display of the UI screen may correspond to the user-oblivious response period. The operation in step 1210 may be performed by the controller 650 shown in FIG. 6.

If the display of the UI screen has not been completed (that is, if it corresponds to the user perception response period), the electronic device 100 may calculate a frequency of the current sampling cycle in step 1220. The frequency of the current sampling cycle may be calculated in order to determine whether or not the frequency of the currently executed path is appropriate. The operation in step 1220 may be omitted depending on the implementation of the electronic device 100. In addition, the operation in step 1220 may be performed in combination with the operations in other steps.

In step 1230, the electronic device 100 may determine whether or not it is possible to increase a frequency of a next sampling cycle based on the calculated frequency of the current sampling cycle and the current state of the electronic device 100. If it is impossible to increase the frequency, the electronic device 100 may maintain the frequency of the next sampling cycle at the frequency of the current sampling cycle in step 1240. On the other hand, if it is possible to increase the frequency, the electronic device 100 may increase the frequency of the next sampling cycle to be greater than the frequency of the current sampling cycle in step 1250. The operations in steps 1220 to 1250 may be performed by the controller 650 shown in FIG. 6.

When the display of the UI screen is completed (that is, when it corresponds to the user-oblivious response period), the electronic device 100 may calculate a frequency of the current sampling cycle in step 1260. The operation in step 1260 may be omitted depending on the implementation of the electronic device 100. In addition, the operation in step 1260 may be performed in combination with the operations in other steps.

In step 1270, the electronic device 100 may determine whether or not it is possible to reduce a next sampling cycle based on the calculated frequency of the current sampling cycle and the current state of the electronic device 100. If it is impossible to reduce the frequency, the electronic device 100 may maintain the frequency of the next sampling cycle at the frequency of the current sampling cycle in step 1280. On the other hand, if it is possible to reduce the frequency, the electronic device 100 may reduce the frequency of the next sampling cycle to be lower than the frequency of the current sampling cycle in step 1290. The operations in steps 1260 to 1290 may be performed by the controller 650 shown in FIG. 6.

The electronic device 100 may increase the frequency of the user perception response period in order to thereby increase the processing speed of the path corresponding to the user perception response period. This enables the user to perceive an increase in the processing speed of the application program (that is, the improvement of the performance of the application program). In addition, the electronic device 100 may reduce the frequency of the user-oblivious response period to thus reduce power consumption of the electronic device 100.

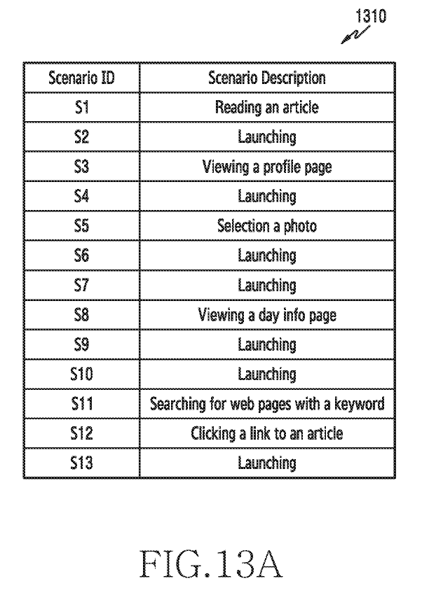

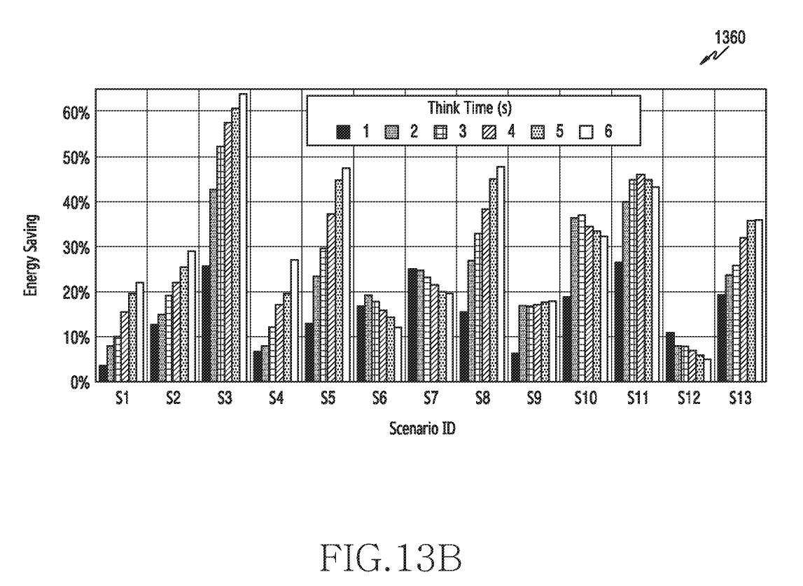

FIGS. 13A and 13B show an energy saving effect according to the first embodiment.

Referring to FIG. 13A, a table 1310 includes scenario IDs of the application program executed in the electronic device 100 shown in FIG. 1, and brief descriptions of the scenarios.

The respective scenarios corresponding to the scenario IDs may perform different kinds of functions (e.g., reading an article, viewing a profile page, or the like), or may include different operations even if they perform the same function (e.g., launching).

Referring to FIG. 13B, a graph 1360 shows an energy saving effect of the electronic device 100 for each scenario, according to various embodiments. The horizontal axis of the graph 1360 may denote the respective scenarios (S1 and S2 to S13). The vertical axis of the graph 1360 may denote the energy saving effect represented as a percentage. The vertical axis of the graph 1360 may represent, as a percentage, the ratio of the amount of energy normally used to the amount of energy used when the frequency is reduced according to various embodiments {i.e., (the amount of energy used when the frequency is reduced)/(the amount of energy normally used)}. ‘Think Time’ displayed at the top of the graph may indicate a period from the time at which the display of the UI is completed to the time at which a new user input is detected. In other words, ‘Think Time’ may refer to the user-oblivious response period. The ‘Think Time’ has a unit of seconds.

As shown in the graph 1360, the electronic device, according to various embodiments, may reduce power consumption by reducing the frequency in the user-oblivious response period. The reduction in the power consumption may increase as the user-oblivious response period becomes longer.

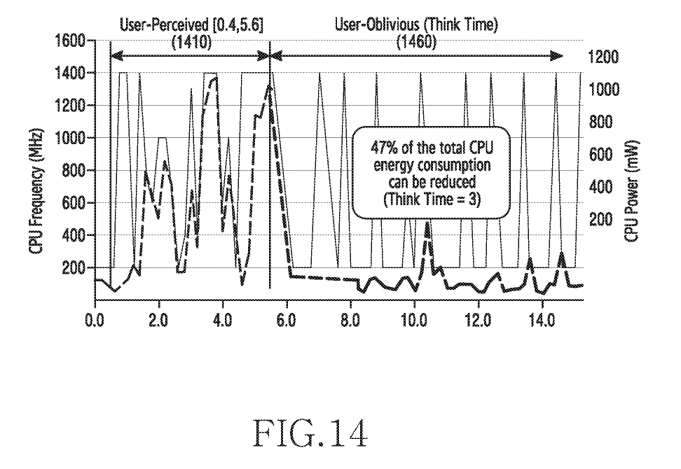

FIG. 14 is a graph showing changes in the frequency and the power consumption according to the first embodiment. The graph of FIG. 14 may be derived through the operation in step 930 of FIG. 9 or the operations in FIG. 12.

Referring to FIG. 14, the horizontal axis of the graph in FIG. 14 may denote an extraction time of an application program. The horizontal axis of the graph in FIG. 14 may have a unit of seconds. The left vertical axis of the graph in FIG. 14 may indicate a change the frequency. The left vertical axis of the graph in FIG. 14 may have a unit of megahertz (Mhz).

The right vertical axis of the graph in FIG. 14 may represent a change in the power consumption. The right vertical axis of the graph in FIG. 14 may have a unit of milliwatts (mW). ‘User Perceived’ 1410 may denote a user perception response period ranging from 0.4 to 5.6 seconds. ‘User Oblivious’ 1460 may denote a user-oblivious response period ranging from 5.6 to about 14 seconds. A solid line in the graph of FIG. 14 may indicate a frequency change. The dotted line in the graph of FIG. 14 may indicate a power consumption change. The electronic device 100, according to various embodiments, may recognize the termination time (i.e., 5.6 seconds) of the user perception response period (i.e., ‘User Perceived’ 1410). As shown by the solid line in the graph of FIG. 14, the electronic device 100 may reduce the frequency in the user-oblivious response period (i.e., ‘User Oblivious’ 1460). As shown in the dotted line in the graph of FIG. 14, the electronic device 100 may reduce the power consumption by adjusting the frequency to be reduced. For example, in the case where a next input is applied to the electronic device 100 after 3 seconds, the electronic device 100 can reduce the power consumption by about 47%.

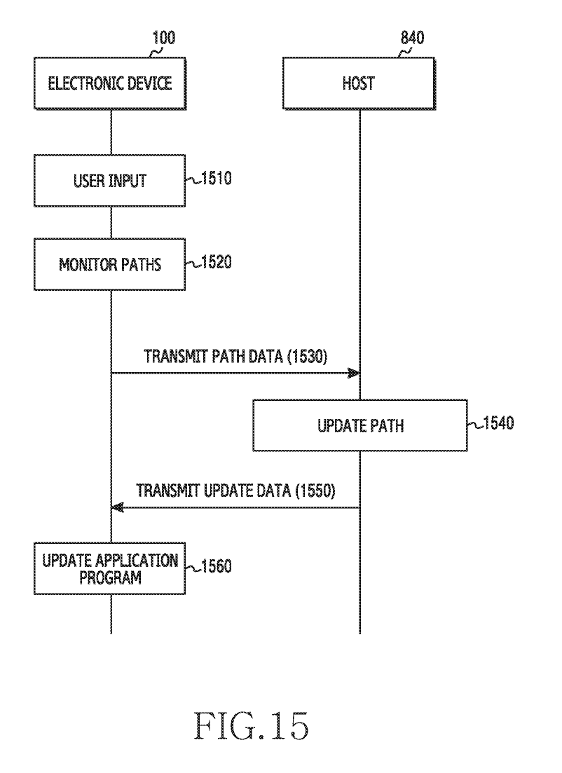

FIG. 15 illustrates an operation procedure between an electronic device and a host according to the second embodiment. This operation procedure may be performed by the electronic device 100 shown in FIG. 1 and the host 840 shown in FIG. 8

Referring to FIG. 15, the electronic device 100 shown in FIG. 1 may detect a user input in step 1510. The user input may be an operation for executing an application program stored in the electronic device 100. The operation in step 1510 may be performed by at least one of the input unit 610 or the controller 650 shown in FIG. 6.

In step 1520, the electronic device 100 may monitor the paths generated by the execution of the application program. The electronic device 100 may detect the completion time of the user perception response period through the monitoring as in the operation of step 920 in FIG. 9 or the operations in FIG. 10, thereby detecting the paths. The operation in step 1520 may be performed by the controller 650 shown in FIG. 6.

In step 1530, the electronic device 100 may transmit data including information on the paths to the host 840. The operation in step 1530 may be performed by at least one of the communication unit 610 or the controller 650 shown in FIG. 6.

In step 1540, the host 840 may update the execution path of the application program based on the path information included in the received data. For example, the host 840 may receive a plurality of paths for the application program. The host 840 may select paths corresponding to the user perception response period from among the plurality of received paths. The host 840 may select a centric and critical path from among the selected paths corresponding to the user perception response period. The host 840 may analyze the selected centric and critical path. More specifically, the host 840 may identify operations that may switch to a background or another path among the operations included in the centric and critical path. The host 840 may generate data that allows the application program of the electronic device 100 to be updated with identified operations.

In step 1550, the host 840 may transmit the update data to the electronic device 100. In response thereto, the electronic device 100 may receive the update data. The operation in step 1550 may be performed by at least one of the communication unit 610 or the controller 650 shown in FIG. 6.

In step 1560, the electronic device 100 may update the application program by applying the update data. The operation in step 1560 may be performed by the controller 650 shown in FIG. 6.

The electronic device 100 may improve the performance of the application program through the operations in steps 1510 to 1560. More specifically, the electronic device 100 may shorten the execution time of the application program corresponding to the user perception response period.

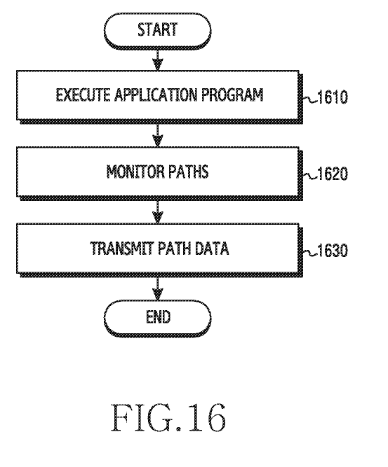

FIG. 16 is a flowchart illustrating the operation of an electronic device according to the second embodiment. This operation flow may be performed by the electronic device 100 shown in FIG. 1.

Referring to FIG. 16, the electronic device 100 may execute an application program in step 1610. The execution of the application program may be triggered by a user input or the like. The operation in step 1610 may be performed by at least one of the input unit 610 or the controller 650 shown in FIG. 6.

In step 1620, the electronic device 100 may monitor the paths generated by the execution of the application program. The operation in step 1620 may correspond to the operation in step 920 of FIG. 9 or the operations of FIG. 10. The operation in step 1620 may be performed by the controller 650 shown in FIG. 6.

In step 1630, the electronic device 100 may transmit data including the information on the monitored paths to the host 840 shown in FIG. 8. The operation in step 1630 may be performed by at least one of the communication unit 610 or the controller 650 shown in FIG. 6.

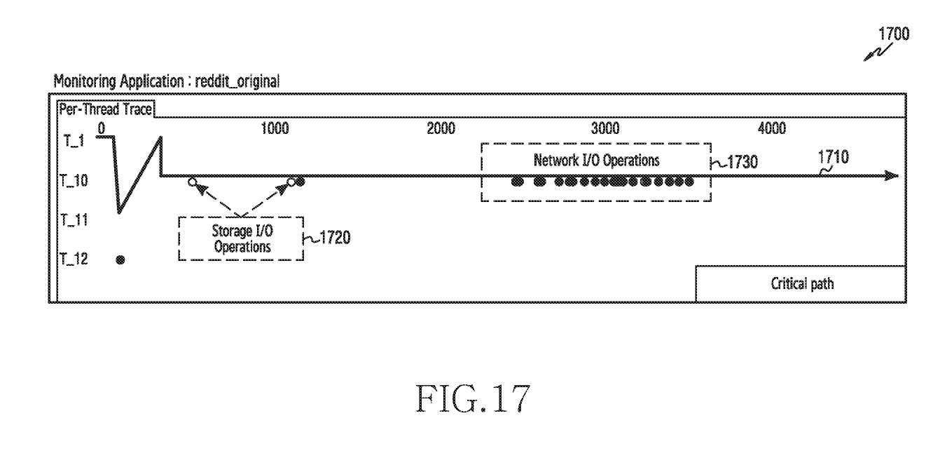

FIG. 17 is a GUI showing a centric and critical path according to the second embodiment. Such a GUI may be displayed in the host 840 shown in FIG. 8.

Referring to FIG. 17, the GUI 1700 may display a centric and critical path 1710 of the application program of the electronic device 100. The centric and critical path 1710 may include a plurality of operations. A developer may analyze a plurality of operations included in the centric and critical path 1710 through the GUI 1700. For example, the developer may analyze, through the GUI 1700, the time at which each operation starts, the time at which each operation ends, the time taken for the completion of each operation, a ration of each operation to the centric and critical path 1710, and the like. Based on the analysis above, the developer may extract, from the centric and critical path 1710, the operations that take a long time differently from the intention. In addition, the developer may extract, from the centric and critical path 1710, kinds of operations that are not suitable for the updating of the UI based on the analysis above. For example, the developer may extract a storage I/O operation 1720 and a network I/O operation 1730, which have low relativeness with respect to the UI and have high complexity, from the centric and critical path 1710.

An operating method of an electronic device, according to the various embodiments above, may include the steps of: executing an application program in response to an input by a user; detecting a user perception response period in an execution period of the application program; and transmitting information on the user perception response period. The execution of the application program may be comprised of a plurality of execution paths. The plurality of execution paths may include one of a first execution path associated with the display of at least one user interface screen for the application program, a second execution path supporting the first execution path, or a third execution path for processing an input received by the electronic device, or a combination thereof.

In various embodiments, the user perception response period may include a period from the time at which the application program is executed to the time at which the display of at least one user interface for the application program is completed, and the method may further include a step of increasing a processing speed of the application program in the user perception response period. The step of increasing the processing speed of the application program in the user perception response period may include the steps of: calculating a frequency of a current sampling cycle corresponding to the user perception response period; and increasing a frequency of a next sampling cycle to be higher than the calculated frequency, thereby increasing the processing speed of the application program in the user perception response period.

In various embodiments, the user perception response period may include a period from the time at which the application program is executed to the time at which the display of at least one user interface for the application program is completed, and the method may further include a step of reducing a processing speed of the application program in a user-oblivious response period from the time at which the display of at least one user interface is completed to the time at which the execution of the application program is terminated, among the execution period. The step of reducing the processing speed of the application program in the user-oblivious response period may include the steps of: calculating a frequency of a current sampling cycle corresponding to the user-oblivious response period; and reducing a frequency of a next sampling cycle to be lower than the calculated frequency of the period, thereby adjusting the processing speed of the application program to be reduced in the user-oblivious response period.

In various embodiments, the method may further include the step of transmitting first data including a plurality of paths to a second electronic device. The second electronic device may be an electronic device of a developer of the program. Furthermore, the method may further include the steps of: receiving second data from the second electronic device; and updating the application program based on the second data, and the second data may include information to shorten the user perception response period from the execution time of the program to the time at which the updating of the display of at least one user interface for updating the application program is completed.

Methods stated in claims and/or specifications according to various embodiments may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the present disclosure as defined by the appended claims and/or disclosed herein.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or other type optical storage devices, or a magnetic cassette. Alternatively, any combination of some or all of the may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the present disclosure, a component included in the present disclosure is expressed in the singular or the plural according to a presented detailed embodiment. However, the singular form or plural form is selected for convenience of description suitable for the presented situation, and various embodiments of the present disclosure are not limited to a single element or multiple elements thereof. Further, either multiple elements expressed in the description may be configured into a single element or a single element in the description may be configured into multiple elements.

Although the embodiment has been described in the detailed description of the present disclosure, the present disclosure may be modified in various forms without departing from the scope of the present disclosure. Therefore, the scope of the present disclosure should not be defined as being limited to the embodiments, but should be defined by the appended claims and equivalents thereof.

1. A method for operating an electronic device, the method comprising:
executing an application program in response to an input by a user;
detecting a user perception response period in an execution period of the application program; and
transmitting information on the user perception response period.

2. The method of claim 1, wherein executing the application program is performed through a plurality of execution paths.

3. The method of claim 2, wherein the plurality of execution paths include one of a first execution path associated with display of at least one user interface screen for the application program, a second execution path supporting the first execution path, or a third execution path for processing an input received by the electronic device, or a combination thereof.

4. The method of claim 1, wherein the user perception response period includes a period from the time at which the application program is executed to the time at which display of at least one user interface for the application program is completed, and further comprising a step of increasing a processing speed of the application program in the user perception response period.

5. The method of claim 4, wherein increasing the processing speed of the application program in the user perception response period comprises:
calculating a frequency of a current sampling cycle corresponding to the user perception response period; and
increasing a frequency of a next sampling cycle to be higher than the calculated frequency, thereby increasing the processing speed of the application program in the user perception response period.

6. The method of claim 1, wherein the user perception response period includes a period from the time at which the application program is executed to the time at which display of at least one user interface for the application program is completed, and further comprising a step of reducing a processing speed of the application program in a user-oblivious response period from the time at which the display of at least one user interface is completed to the time at which the execution of the application program is terminated, among the execution period.

7. The method of claim 6, wherein reducing the processing speed of the application program in the user-oblivious response period comprises:
calculating a frequency of a current sampling cycle corresponding to the user-oblivious response period; and
reducing a frequency of a next sampling cycle to be lower than the calculated frequency of the period, thereby adjusting the processing speed of the application program to be reduced in the user-oblivious response period.

8. An electronic device comprising:
a display;
a transceiver; and
at least one processor,
wherein the at least one processor is configured to:
control the transceiver to transmit and receive data;
control the display to display a user interface (UI);
execute an application program in response to an input by a user;
detect a user perception response period in an execution period of the application program; and
transmit information on the user perception response period.

9. The electronic device of claim 8, wherein the at least one processor is further configured to execute the application program through a plurality of execution paths.

10. The electronic device of claim 9, wherein the plurality of execution paths include one of a first execution path associated with display of at least one user interface screen for the application program, a second execution path supporting the first execution path, or a third execution path for processing an input received by the electronic device, or a combination thereof.

11. The electronic device of claim 8, wherein the user perception response period includes a period from the time at which the application program is executed to the time at which display of at least one user interface for the application program is completed, and
wherein the controller is configured to further increase a processing speed of the application program in the user perception response period.

12. The electronic device of claim 11, wherein the at least one processor is further configured to:
calculate a frequency of a current sampling cycle corresponding to the user perception response period; and
increase a frequency of a next sampling cycle to be higher than the calculated frequency, thereby increasing the processing speed of the application program in the user perception response period.

13. The electronic device of claim 8, wherein the user perception response period includes a period from the time at which the application program is executed to the time at which display of at least one user interface for the application program is completed, and
wherein the controller is configured to further reduce a processing speed of the application program in a user-oblivious response period from the time at which the display of at least one user interface is completed to the time at which the execution of the application program is terminated among the execution period.

14. The electronic device of claim 13, wherein the at least one processor is further configured to:
calculate a frequency of a current sampling cycle corresponding to the user-oblivious response period; and
reduce a frequency of a next sampling cycle to be lower than the calculated frequency of the period, thereby adjusting the processing speed of the application program to be reduced in the user-oblivious response period.

15. The method of claim 2, further comprising:
transmitting, to a second electronic device, first data including the plurality of paths.

16. The method of claim 15, wherein the second electronic device is an electronic device of a developer of the application program.

17. The method of claim 15,
further comprising:
receiving, from the second electronic device, second data; and
updating the application program based on the second data, wherein the second data includes information to shorten the user perception response period which is from time at which the application program is executed to time at which updating of display of at least one user interface for the application program is completed.

18. The electronic device of claim 9,
wherein the at least one processor is further configured to control the transceiver to transmit, to a second electronic device, first data including the plurality of paths.

19. The electronic device of claim 18, wherein the second electronic device is an electronic device of a developer of the application program.

20. The electronic device of claim 18,
wherein the at least one processor is further configured to:
control the transceiver to receive, from the second electronic device, second data; and
update the application program based on the second data,
wherein the second data includes information to shorten the user perception response period which is from time at which the application program is executed to time at which updating of display of at least one user interface for the application program is completed.
